(19) United States
(12) Patent Application Publication
(10) Pub. No.: US 2020/0068145 A1
(43) Pub. Date: Feb. 27, 2020

(54) MULTI-RESOLUTION UNCOOLED MICROBOLOMETER FOCAL PLANE ARRAY

(71) Applicant: BAE Systems Information and Electronic Systems Integration Inc., Nashua, NH (US)

(72) Inventors: Daniel P. Lacroix, Westford, MA (US); Robert H. Murphy, Lancaster, MA (US)

(73) Assignee: BAE Systems Information and Electronic Systems Integration Inc., Nashua, NH (US)

(21) Appl. No.: 16/106,296

(22) Filed: Aug. 21, 2018

(51) Int. Cl. H04N 5/33; H04N 5/365; H04N 3/14

(52) U.S. Cl. CPC H04N 5/33; H04N 3/14; H04N 5/3651

(57) ABSTRACT

A multiple resolution focal plane array, the multiple resolution focal plane array having a plurality of bolometers and a readout integrated circuit connected to the plurality of bolometers, wherein the readout integrated circuit is configured to accumulate signal-induced current collected from each bolometer during an integration interval and then transfer the resultant signal onto output taps for readout. The readout integrated circuit is configured to allow a selection between at least two bolometer configurations, a first configuration where bolometers are combined into pixels comprising N×N series/parallel groupings of bolometers and a second configuration where the bolometers are used individually, forming pixels comprising only a single bolometer.

### FIELD

The disclosure relates to focal plane arrays, and, more particularly, to multiple resolution focal plane arrays.

### BACKGROUND

Digital detection of visual and infrared (IR) images is a very widely used technology, having applications ranging from consumer-oriented cameras and video apparatuses to law enforcement and military equipment. For virtually all of these applications, there is a growing demand for higher image pixel counts, higher pixel density, increased sensitivity, improved dynamic range, lower power consumption, faster image processing, and the ability to switch between modes offering different balances of these characteristics, dependent on the requirements present at a given time.

At the heart of all digital imaging systems, which may be referred to generally as Solid State Area Array Imaging Devices (SSAAIDs), is the Focal Plane Array (“FPA”), which is a two-dimensional array of elements upon which an image is focused, whereby each of the FPA elements or “pixels” develops an analog output “signal charge” that is proportional to the intensity of the electromagnetic radiation that is impinging on it over a given interval of time. This signal charge can then be measured and used to produce an image.

Current SSAAIDs, however, can only operate at a single resolution or, if they are able to operate at alternate resolutions, do not consume less power by doing so. This results in current SSAAIDs, which must be designed to accommodate the highest required resolution, consuming more power than is necessary during normal usage, which limits their usage and/or resolution in power-sensitive applications.

What is needed, therefore, is a cost-effective way to reduce SSAAID power requirements while obtaining less than full resolution images.

### SUMMARY

A multi-resolution uncooled FPA using microbolometers as electromagnetic radiation detecting elements that offers significant power and performance benefits is herein disclosed.

In embodiments, the FPA can be operated in a high resolution, higher power mode and then switched to a ½× resolution, lower power mode while maintaining full fill factor and field of view. In embodiments, processing ¼ of the pixels when full resolution is not needed yields a comparable reduction in system power, making this solution ideal for handheld, battery-powered applications.

In embodiments, resolution and power reduction is accomplished by forming 2×2 composite pixels made up of series/parallel microbolometer combinations. The approach, using the teachings provided herein, can be extended to 3×3, 4×4, . . . , N×N, composite pixels. In such embodiments, the electrical behavior yields response and noise performance equivalent to a single bolometer implementation.

The thermal properties of embodiments of the composite pixel disclosed herein allow for increased biasing, yielding enhanced Noise equivalent temperature difference (NETD) performance relative to a single pixel.

Embodiments require only the addition of switches outside of the input cell array combined with control circuitry and enable innovative imaging system implementations with lower Size, Weight, Power, and Cost (SWaP-C).

One embodiment of the present disclosure provides a multiple resolution focal plane array, the multiple resolution focal plane array comprising: a focal plan array comprising a plurality of bolometers arranged into a plurality of columns and rows and a readout integrated circuit connected to the plurality of bolometers, wherein the readout integrated circuit is configured to accumulate signal-induced current collected from each bolometer during an integration interval and then transfer the resultant signal onto output taps for readout, and wherein the readout integrated circuit is configured to allow a selection between at least two bolometer configurations, a first configuration where bolometers are combined into super pixels comprising N×N series/parallel groupings of bolometers and a second configuration where the bolometers are used individually, forming pixels comprising only a single bolometer.

Another embodiment of the present disclosure provides such a multiple resolution focal plane array wherein selection between the at least two bolometer configurations is accomplished using switches internal to the readout integrated circuit that are positioned between adjacent columns of pixels.

A further embodiment of the present disclosure provides such a multiple resolution focal plane array wherein selection between the at least two bolometer configurations is enabled by connecting detector common and column bus lines of adjacent columns of the readout integrated circuit with switches.

Yet another embodiment of the present disclosure provides such a multiple resolution focal plane array wherein the switches are added below a bottom portion of the focal plane array.

A yet further embodiment of the present disclosure provides such a multiple resolution focal plane array wherein a total of seven switches are used to connect detector common and column bus lines of adjacent columns of the readout integrated circuit.

Still another embodiment of the present disclosure provides such a multiple resolution focal plane array wherein the readout integrated circuit is configured to use a dual row bias per line time to maximize pulse bias time.

A still further embodiment of the present disclosure provides such a multiple resolution focal plane array wherein the selection between at least two bolometer configurations is accomplished electronically through the use of switches that, when used in combination with one another, re-configure row select signals and column interconnect signals between an input cell array and column signal processing circuitry.

Even another embodiment of the present disclosure provides such a multiple resolution focal plane array wherein the selection between at least two bolometer configurations is performed on-FPA.

An even further embodiment of the present disclosure provides such a multiple resolution focal plane array wherein each parallel/series grouping of bolometers uses at least two thermal-only contacts and at least 4 thermal/electrical contacts to connect adjacent bolometers when in the first configuration.

A still even another embodiment of the present disclosure provides such a multiple resolution focal plane array wherein the bolometers connected in series are connected to one another by thermal contacts only and the bolometers connected in parallel are connected to the readout integrated circuit and to adjacent series-connected bolometers by thermal/electrical contacts, when in the first configuration.

A still even further embodiment of the present disclosure provides such a multiple resolution focal plane array wherein the thermal/electrical contacts are tungsten posts.

Still yet another embodiment of the present disclosure provides such a multiple resolution focal plane array wherein the tungsten posts connect the bolometers to the readout integrated circuit.

A still yet further embodiment of the present disclosure provides such a multiple resolution focal plane array wherein bolometers in a column are connected in series.

Even yet another embodiment of the present disclosure provides such a multiple resolution focal plane array wherein bolometers in each row of the focal plane array are selected simultaneously through a set of switches on the readout integrated circuit.

An even yet further embodiment of the present disclosure provides such a multiple resolution focal plane array wherein the switches are controlled by hardware.

Still even yet another embodiment of the present disclosure provides such a multiple resolution focal plane array wherein the switches are controlled by software.

A still even yet further embodiment of the present disclosure provides such a multiple resolution focal plane array wherein the software enables the first or second configuration automatically, based on criteria selected from the group consisting of battery power, required image quality, and altitude.

Yet still even another embodiment of the present disclosure provides such a multiple resolution focal plane array wherein the focal plane array is configured to operate at a higher bias voltage when in the first configuration, as compared to the second configuration.

One embodiment of the present disclosure provides a multiple resolution focal plane array multiple resolution focal plane array, the multiple resolution focal plane array comprising: a focal plan array comprising a plurality of bolometers arranged into a plurality of columns and rows and a readout integrated circuit connected to the plurality of bolometers, wherein the readout integrated circuit is configured to accumulate signal-induced current collected from each bolometer during an integration interval and then transfer the resultant signal onto output taps for readout, and wherein the readout integrated circuit is configured to allow a selection between at least two bolometer configurations, a first configuration where bolometers are combined into super pixels comprising N×N series/parallel groupings of bolometers and a second configuration where the bolometers are used individually, forming pixels comprising only a single bolometer, wherein selection between the at least two bolometer configurations is enabled by connecting detector common and column bus lines of adjacent columns of the readout integrated circuit with switches, and wherein the switches are added below a bottom portion of the focal plane array.

One embodiment of the present disclosure provides a multiple resolution focal plane array, the multiple resolution focal plane array comprising: a focal plan array comprising a plurality of bolometers arranged into a plurality of columns and rows and a readout integrated circuit connected to the plurality of bolometers, wherein the readout integrated circuit is configured to accumulate signal-induced current collected from each bolometer during an integration interval and then transfer the resultant signal onto output taps for readout, and wherein the readout integrated circuit is configured to allow a selection between at least two bolometer configurations, a first configuration where bolometers are combined into super pixels comprising N×N series/parallel groupings of bolometers and a second configuration where the bolometers are used individually, forming pixels comprising only a single bolometer, wherein selection between the at least two bolometer configurations is enabled by connecting detector common and column bus lines of adjacent columns of the readout integrated circuit with switches, wherein the switches are added below a bottom portion of the focal plane array, and wherein the bolometers connected in series are connected to one another by thermal contacts only and bolometers connected in parallel are connected to the readout integrated circuit and to adjacent series-connected bolometers by thermal/electrical contacts, when in the first configuration.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1A is a schematic showing microbolometers connected to a readout integrated circuit through posts, in accordance with embodiments of the present disclosure;

FIG. 1B is a schematic showing microbolometers connected to a readout integrated circuit through posts, where two posts act only as thermal contacts while the remaining posts act as both thermal and electrical contacts, in accordance with embodiments of the present disclosure;

FIG. 2A is a schematic showing current flow, based on voltage and resistance, through a single microbolometer, in accordance with embodiments of the present disclosure;

FIG. 2B is a schematic showing current flow, based on voltage and resistance, through a group of four microbolometers, wherein two sets of microbolometers wired in series using only thermal contacts are connected in parallel, in accordance with embodiments of the present disclosure;

FIG. 2C is a schematic showing two microbolometers connected in series, which is also referred to herein as a series leg pair, using only a thermal contact, in accordance with embodiments of the present disclosure;

FIG. 2D is a schematic showing a parallel combination of series pairs of microbolometers, in accordance with embodiments of the present disclosure;

FIG. 3 is a schematic showing two representative columns of pixels operating at full resolution, where bolometers are selected in row pairs, with each column having two column lines that connect to respective analog signal processing chains, in accordance with embodiments of the present disclosure;

FIG. 4 is a schematic showing a bolometer array configured to use switches internal to the array to allow for reduced resolution and power options, in accordance with embodiments of the present disclosure;

FIG. 5 is a schematic showing a bolometer array having an alternative configuration of detector common and column bus lines, compared to FIG. 3, that allows for reduced resolution and power options, in accordance with embodiments of the present disclosure;

FIG. 6 is a schematic showing a bolometer array having an alternative configuration of detector common and column bus lines, compared to FIG. 3, that allows for reduced resolution and power options, in accordance with embodiments of the present disclosure;

FIG. 7 is a chart describing responsivity v. bias, with and without pulse bias contribution, of embodiments of the present disclosure; and

FIG. 8 is a chart describing response v. bolometer bias of embodiments of the present disclosure.

### DETAILED DESCRIPTION

As a preliminary matter, a microbolometer 102 is a specific type of bolometer 102, which is an electrical instrument for measuring radiant energy that may be thought of as a resistor. Among other uses, microbolometers 102 are suitable for use as detector elements in thermal cameras.

In a typical microbolometer 102, infrared radiation with wavelengths between 7.5-14 μm strikes a detector material, heating it. This change in temperature changes the sensor's electrical resistance in a predictable fashion, allowing for the intensity of incident radiation in this range during a given time to be inferred based on the measured change in electrical resistance over this same period. Although the term microbolometer 102 has a specific meaning, as defined above, the behavior of microbolometers 102 and bolometers are identical for the purposes of the present disclosure and the terms may be used interchangeably herein when describing their behavior.

Furthermore, pixel binning, which may also be referred to as CCD binning, is the process of combining neighboring pixels on an image sensor (e.g. a CCD) into a “super pixel”. This super pixel represents the area of all the individual pixels contributing to the charge. For example, in 2×2 pixel binning, the charge from a square of 4 adjacent pixels is combined into 1, and in 3×3 CCD binning, the charge from a square of 9 adjacent pixels is combined into 1.

Pixel binning provides several benefits, including: an increase in signal equal to the number of pixels binned, which allows the sensor to detect fainter signals and reduces exposure time; an increase in frame rate, due to the reduction in exposure time and a reduction in the number of pixels to be measured; an increase in the Signal to Noise Ratio (SNR), which results from a single read error being applied to the charge of the binned pixels rather than the addition of multiple read errors if the pixels were read individually; and an increase in the dynamic range of the sensor, which results from the larger charge capacity of the summing node. Pixel binning, however, also results in a loss of image resolution equal to the binning level and an increase in dark current proportional to the number of pixels binned. Most pertinent to the present disclosure is the improvement in SNR provided by pixel binning.

Pixel binning “on-FPA”, or within the focal plane array itself, in accordance with embodiments of the present disclosure, reduces system power requirements, since FPA data does not need to be transferred at high speeds and the data does not need to be processed externally. Embodiments also provide a method for reducing overall system power through a reduction of system resolution and, consequently, total image data.

In embodiments, N×N groups of microbolometers (resistors) 102 are electrically and/or thermally combined in a series/parallel configuration so as to create a composite resistance equal to that of an individual pixel bolometer 102. This yields a composite microbolometer 102 with the ability to achieve better signal-to-noise ratio at the expense of pixel density (i.e. resolution). The proposed approach realizes the composite N×N pixels without changes to a readout integrated circuit (ROIC) input cell. Instead, embodiments electronically re-configure row select signals and column interconnect signals between an input cell array and a column signal processing circuitry to allow for both creation of composite N×N pixels as well as allowing for various groupings of pixels that result in different resolutions and power requirements.

Embodiments of the present solutions can be performed on-FPA, rather than within an imaging engine, as is common in the prior art. In embodiments, an imaging engine is used to perform signal processing functions such as real-time spatial non-uniformity correction (NUC) and other functions necessary to generate an image that is suitable for display or further processing. In on-FPA embodiments, the pixel binning process is more efficient, significantly reducing output data rates and eliminating the need for external signal binning. The signal binning process occurs, in embodiments, through proper electrical and thermal interconnection of an N×N group of microbolometers 102 and requires no additional signal processing circuitry. The new methods and circuits disclosed herein use existing interconnect wiring and require a minimum of new circuitry.

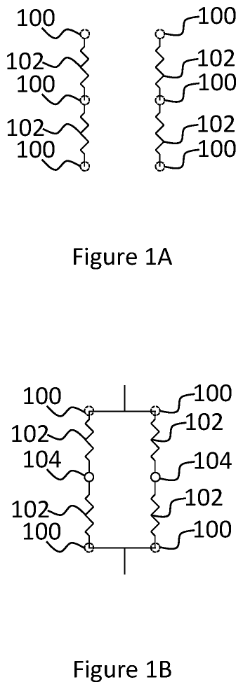

Now referring to FIG. 1A, a 2×2 group of microbolometers 102 connected by electrical/thermal connections 100 in a series/parallel configuration are shown. In embodiments, these thermal/electrical connections are tungsten posts that connect the microbolometers 102 to an ROIC.

Now referring to FIG. 1B, the 2×2 group of microbolometers 102, as in FIG. 1A, is shown. However, in FIG. 1B, the series-connected microbolometers 102 are connected to one another and to an ROIC by thermal contacts 104 only. It should be noted that, as the resistance of microbolometers 102 changes in response to heat, this configuration does not change the microbolometers' 102 ability to measure the amount of electromagnetic radiation of a given spectrum incident on the group during a predetermined interval (e.g. an integration interval).

In embodiments, microbolometers 102 in a column are connected in series to effectively allow for one post per pixel. In such embodiments, bolometers 102 in each row are selected simultaneously through a set of switches 302 on an ROIC. By changing the switch 302 configuration, a group of 4 microbolometers 102, in the case of a 2×2 group of microbolometers 102, can be connected in a series/parallel arrangement, yielding the same effective resistance as a single bolometer 102. This reduces the resolution in both dimensions by a factor of 2 and the total number of pixels which need to be read out by a factor of 4. Both FPA and imaging engine power is thereby reduced in such embodiments, at the expense of resolution. Importantly, the configuration state of such embodiments can be set through software and/or hardware that controls the state of these switches 302, allowing for full resolution where it is needed and lower resolution where the power-saving benefits of that configuration outweigh the need for enhanced resolution.

Furthermore, since the individual microbolometers 102 remain physically connected to the substrate through their respective posts 100/104, their individual thermal behavior remains unchanged→Thermal time constant and pulse bias self-heating behavior is the same in either mode. It will be shown herein that the FPA sensitivity (SNR) is also maintained between the two operating modes. As would be apparent to one of ordinary skill in the art, the same equivalence can be made for a 3×3, 4×4, etc., composite pixel configuration in accordance with embodiments disclosed herein.

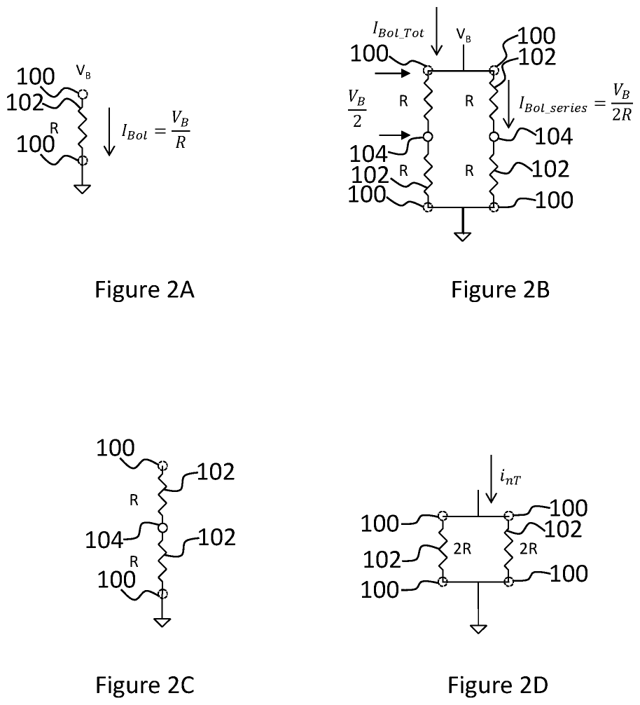

Now referring to FIGS. 2A through 2D, it will be mathematically shown that the response of N×N groups of microbolometers 102 is equivalent to a single bolometer 102 configuration while noise, under some conditions, is lessened. More specifically referring to FIG. 2A, which shows a single microbolometer 102, change in resistance due to scene temperature, ΔT, is provided by the following equations:

ΔR=αRΔT Equation 1

### Where:

### ΔR=Change in Bolometer 102 Resistance

### R=Bolometer 102 Resistance

### α=Bolometer 102 Temperature Coefficient of Resistance (TCR)

### ΔT=Change in Bolometer 102 Resistance Due to Scene Temperature

Bolometer 102 current is then provided by:

$${I}_{Bol} = \frac{{V}_{B}}{R} \qquad Equation 2$$

### Where:

### R=Bolometer 102 Resistance

### V_{B}=Bolometer 102 Voltage

### I_{Bol}=Bolometer 102 Current

The derivative of bolometer 102 current as a function of resistance is then provided by:

$$\frac{\partial {I}_{Bol}}{\partial R} = - \frac{{V}_{B}}{{R}^{2}} \qquad Equation 3$$

### Where:

### R=Bolometer 102 Resistance

### V_{B}=Bolometer 102 Voltage

### I_{Bol}=Bolometer 102 Current

Change in current (ΔI_{Bol}) as a function of the change in resistance (ΔR), in the case of a single bolometer 102, is then provided by the following equation:

$$Δ {I}_{Bol} = - \frac{{V}_{B}}{R} \frac{Δ R}{R} \qquad Equation 4$$

### Where:

### ΔI_{Bol}=Change in Bolometer 102 Current

### V_{B}=Bolometer 102 Voltage

### ΔR=Change in Bolometer 102 Resistance

### R=Bolometer 102 Resistance

Substitution of Equation 1 into Equation 4 then provides Equation 5, shown below, which describes how current across the bolometer 102 changes as a function of voltage, resistance, and temperature, taking into account the bolometer's 102 Temperature Coefficient of Resistance (TCR):

$$Δ {I}_{Bol} = - \frac{{V}_{B}}{R} Δ T α \qquad Equation 5$$

### Where:

### ΔI_{Bol}=Change in Bolometer 102 Current

### V_{B}=Bolometer 102 Voltage

### ΔR=Change in Bolometer 102 Resistance

### R=Bolometer 102 Resistance

### α=Bolometer 102 Temperature Coefficient of Resistance (TCR)

### ΔT=Change in Bolometer 102 Resistance Due to Scene Temperature

Now referring to FIG. 2B, it will be shown that the change in bolometer 102 current (i.e. the response) of a 2×2 group of microbolometers 102 is equivalent to the single bolometer 102 configuration described above. As a preliminary matter, change in resistance due to scene temperature, ΔT, is provided by the following equation, which is the same as that used to calculate the change in resistance due to scene temperature, ΔT that was used in the single bolometer 102 calculation performed above:

ΔR=αRΔT Equation 6

### Where:

### ΔR=Change in Bolometer 102 Resistance

### R=Bolometer 102 Resistance

### α=Bolometer 102 Temperature Coefficient of Resistance (TCR)

### ΔT=Change in Bolometer 102 Resistance Due to Scene Temperature

Bolometer 102 current is then provided by:

$${I}_{Bol} = \frac{{V}_{B}}{2 R} \qquad Equation 7$$

### Where:

### R=Bolometer 102 Resistance

### V_{B}=Bolometer 102 Voltage

### I_{Bol}=Bolometer 102 Current

The derivative of bolometer 102 current as a function of resistance is then provided by:

$$\frac{\partial {I}_{Bol}}{\partial R} = - \frac{{V}_{B}}{2 {R}^{2}} \qquad Equation 8$$

### Where:

### R=Bolometer 102 Resistance

### V_{B}=Bolometer 102 Voltage

### I_{Bol}=Bolometer 102 Current

Change in current (ΔI_{Bol}) as a function of the change in resistance (ΔR), in the case of a series leg of the 2×2 bolometer 102 circuit shown in FIG. 2B, is then provided by the following equation:

$$Δ {I}_{Bol} = - \frac{{V}_{B}}{R} \frac{2 Δ R}{2 R} \qquad Equation 9$$

### Where:

### ΔI_{Bol}=Change in Bolometer 102 Current

### V_{B}=Bolometer 102 Voltage

### ΔR=Change in Bolometer 102 Resistance

### R=Bolometer 102 Resistance

Substitution of Equation 6 into Equation 9 then provides Equation 10, shown below, which describes how current across the series bolometer 102 leg changes as a function of voltage, resistance, and temperature, taking into account the bolometer's 102 Temperature Coefficient of Resistance (TCR):

$$Δ {I}_{Bol \_ Series} = - \frac{{V}_{B}}{2 R} Δ T α \qquad Equation 10$$

### Where:

### ΔI_{Bol_Series}=Change in Series Leg Bolometer 102 Current

### V_{B}=Bolometer 102 Voltage

### ΔR=Change in Bolometer 102 Resistance

### R=Bolometer 102 Resistance

### α=Bolometer 102 Temperature Coefficient of Resistance (TCR)

### ΔT=Change in Bolometer 102 Resistance Due to Scene Temperature

The sum of the series legs is then provided by equation 11, shown below:

$$Δ {I}_{Bol \_ Total} = - 2 \frac{{V}_{B}}{2 R} Δ T α \qquad Equation 10$$

Which simplifies to:

$$Δ {I}_{Bol \_ Total} = - \frac{{V}_{B}}{R} Δ T α \qquad Equation 11$$

### Where:

### ΔI_{Bol_Total}=Change in Series Leg Bolometer 102 Current

### V_{B}=Bolometer 102 Voltage

### ΔR=Change in Bolometer 102 Resistance

### R=Bolometer 102 Resistance

### α=Bolometer 102 Temperature Coefficient of Resistance (TCR)

### ΔT=Change in Bolometer 102 Resistance Due to Scene Temperature

As can be inferred from the above equations, first order analysis of bolometer 102 response based on scene temperature induced resistance change demonstrates that the response (change in current) is the same for a single bolometer 102 and a 4-bolometer 102 (2×2) combination, i.e. equations 5 and 11, which describe how current across the bolometer 102 circuits changes as a function of voltage, resistance, and temperature, taking into account the bolometer's 102 Temperature Coefficient of Resistance (TCR), in the case of a single bolometer 102 and a 2×2 bolometer 102 circuit, respectively, are identical.

In light of the above, it could still be argued that a single bolometer 102 may be more responsive, since it is likely to have a larger area, thereby experiencing a higher scene induced ΔT (e.g. a single bolometer 102 may be 24 μm while a 2×2 circuit of bolometers 102 may be 12 μm×4). However, this is not the case because of the relative scaling of other bolometer 102 parameters that contribute to first order response, which are described below in Equation 12 and Chart 1, which uses typical values to demonstrate this concept.

$$Response = \frac{{n}_{opt} {A}_{pix} {IT}_{scene}}{4 {F}^{2}} \frac{α}{G} \frac{{V}_{bias}}{{R}_{bol}} ∝ \frac{{A}_{pix}}{G} \qquad Equation 12$$

### Where:

### G=Thermal Conductance of the Bolometer 102 Legs

F=The F/# of the camera optics

### α=Bolometer 102 Temperature Coefficient of Resistance (TCR)

### R_{bol}=Bolometer 102 Resistance

nₒₚₜ=Optical transmission of the camera optics

### T_{scene}=Scene Temperature

### Aₚᵢₓ=Bolometer Pixel Area

### V_{bias}=Bolometer Voltage Bias

Relative Values*

| Configuration | Aₚᵢₓ | C | G | τ | R_{Bol} | Aₚᵢₓ/G |
|---|---|---|---|---|---|---|
| 12 μm × 4 | 1 | 1 | 1 | 1 | 60 K | 1 |
| 24 μm | 4 | 4 | 4 | 1 | 60 K | 1 |

*This chart illustrates direct parameter scaling with pixel area. In actual practice, reducing pixel area by a factor of 4 has resulted in slightly more aggressive scaling in C and G, closer to a factor of 5, so there is a slight improvement with larger area.

In Chart 1, above:

### C=Thermal Capacitance

### τ=C/G=Thermal Time Constant

### G=Thermal Conductance

### Aₚᵢₓ=Bolometer 102 Pixel Area

### R_{bol} Bolometer 102 Resistance

As can be seen from the above equation, Equation 12, and chart, Chart 1, for a larger pixel, the thermal capacitance, C, increases. To maintain the same thermal time constant, τ=C/G, the thermal conductance, G, must increase by the same factor. So, regarding first order response, the response remains the same.

Noise equivalence between a single bolometer 102 (FIG. 2A) and 2×2 series legs connected in parallel (FIG. 2B) will now be shown. Regarding a single bolometer 102, equivalent voltage noise source may be described by equation 13, produced below.

vₙ²=4kTRB Equation 13

### Where:

vₙ=RMS noise voltage
k=Boltzmann's constant

### T=Temperature (K)

R=Bolometer 102 resistance
B=Noise equivalent bandwidth

For the same single bolometer 102 design, equivalent current noise is provided by Equation 14, shown below.

$${i}_{n}^{2} = \frac{{v}_{n}^{2}}{{R}^{2}} \qquad Equation 14$$

### Where:

vₙ=RMS noise voltage
iₙ=RMS current noise
R=Bolometer 102 resistance

For a series leg pair (i.e. FIG. 2C), equivalent current noise is provided by Equation 15, shown below. More specifically, using Equation 13, describing a single resistor: vₙ²=4kTRB, combined equivalent voltage noise is provided by:

v_{N}²=vₙ²+vₙ² Equation 15

Which simplifies to:

v_{N}²=2vₙ² Equation 15

### Where:

v_{N}=RMS noise voltage

Substituting equation 13 into Equation 15 then provides another way to describe combined equivalent voltage noise, which is shown below, in Equation 16.

v_{N}²=4kT(2R)B Equation 16

### Where:

vₙ=RMS noise voltage
k=Boltzmann's constant

### T=Temperature (K)

R=Bolometer 102 resistance
B=Noise equivalent bandwidth

Equivalent current noise of the series leg pair (FIG. 2C) is then provided by Equation 17, shown below.

$${i}_{N}^{2} = \frac{{v}_{N}^{2}}{{( 2 R )}^{2}} \qquad Equation 17$$

### Where:

vₙ=RMS noise voltage
iₙ=RMS current noise
R=Bolometer 102 resistance

Now regarding a parallel combination of series pairs (FIGS. 2B/2D), summing equation 17 provides Equation 18, shown below.

i_{nT}²=iₙ²+iₙ² Equation 18

Which simplifies to:

i_{nT}²=2i_{N}² Equation 19

### Where:

i_{nT} Total RMS noise current
iₙ=RMS noise current for a single bolometer

Substituting in Equation 14 for iₙ provides Equation 20, shown below:

$${i}_{nT}^{2} = \frac{2 {v}_{N}^{2}}{{( 2 R )}^{2}} = \frac{2 ( 2 {v}_{n}^{2} )}{{( 2 R )}^{2}} \qquad Equation 20$$

Which simplifies to:

$${i}_{nT}^{2} = \frac{{v}_{n}^{2}}{{R}^{2}} \qquad Equation 21$$

### Where:

vₙ=RMS noise voltage
i_{nT} Total RMS noise current
R=Bolometer 102 resistance

Equation 21 provides the current noise of the total series/parallel combination, which is equivalent to that of a single resistor (bolometer 102) of the same total resistance, the current noise of which is described in Equation 14. Said another way, as demonstrated above, first order analysis of bolometer 102 current noise yields the same value for a single bolometer 102 and a 4-bolometer 102 composite (i.e. 2×2). This assumes uncorrelated noise sources, e.g. Johnson noise.

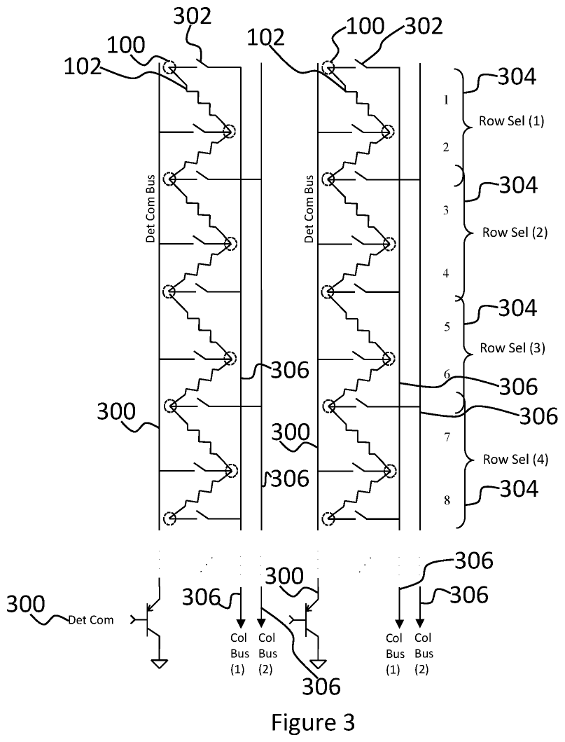

Now referring to FIG. 3, a multiple resolution Focal Plane Array (FPA) Readout Integrated Circuit (ROIC) operating in a full resolution mode is shown. In the embodiment depicted, two representative columns of a total of 1920 are shown. In embodiments, especially for large format arrays (≥768 rows), which bias the bolometers 102 on a line-by-line (row-by-row) basis, dual row bias per line time is used to maximize the pulse bias time. For a given frame readout time, reducing the number of rows that need to be biased proportionally increases the row bias time.

In the embodiment depicted, bolometers 102 are selected, through the use of switches 302, in row pairs 304. Each column has two column lines 306 that connect to respective signal processing chains, which, in embodiments, are analog signal processing chains. FIG. 3 also depicts a single DET_COM (detector common) line 300 being shared by both active bolometers 102 within that column 306.

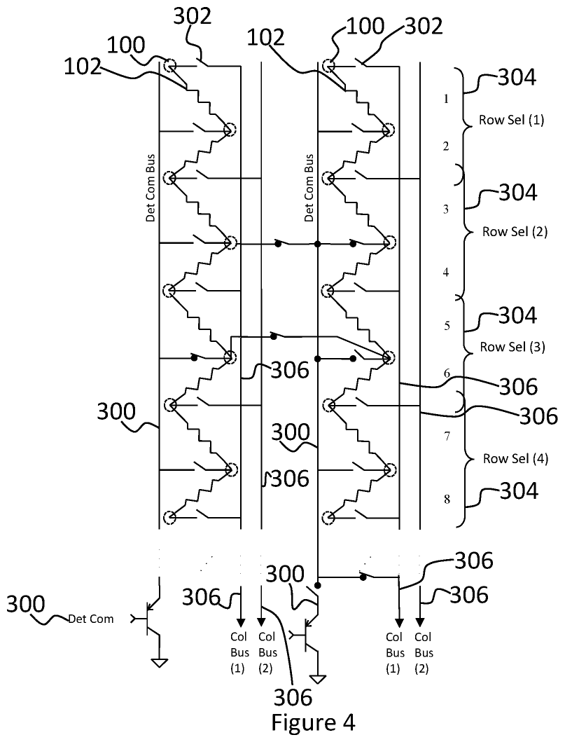

Now referring to FIG. 4, an embodiment of the present disclosure that uses switches 302 internal to the FPA ROIC, which are positioned between the two representative columns, to select between various resolutions is shown. While such a strategy may be used, in embodiments, reconfiguring the bolometer 102 FPA to use switches 302 internal to the FPA requires more complex switching signals and additional switches 302 within what is typically an already densely packed input cell array.

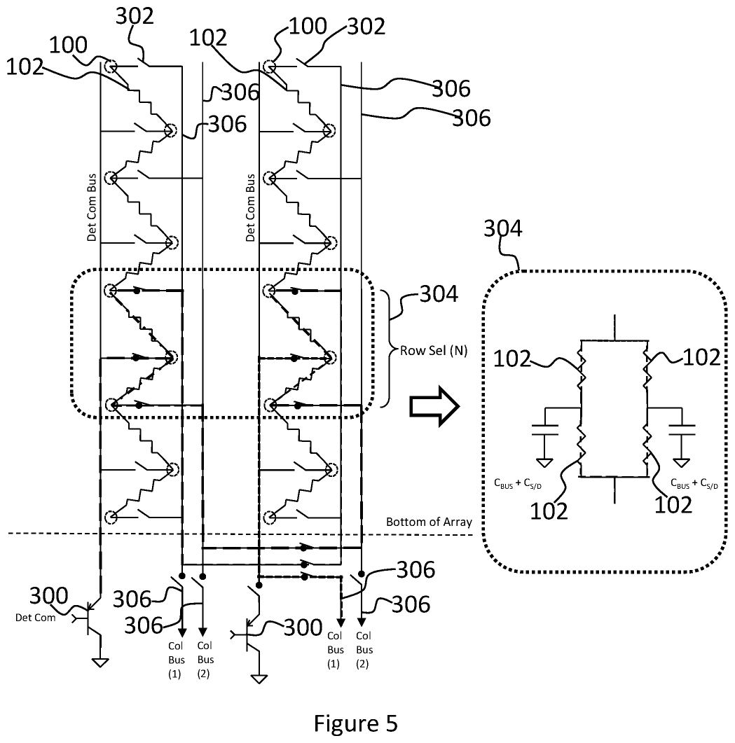

Now referring to FIG. 5, another option to allow switching between multiple resolutions is shown. In FIG. 5, the desired series-parallel combination of four adjacent bolometers 102 is achieved by reconfiguring the DET_COM 300 and COL_BUS 306 lines of adjacent columns and using switches 302 to allow different connection schemes therebetween. Such embodiments have the benefit of requiring no changes or additions to the standard switch 302 configuration of the bolometer 102 FPA. Furthermore, in such embodiments, switches 302 are added below the bottom of the FPA, where ample space is typically available. In embodiments, a total of seven switches are required by such a configuration.

One potential issue with such an embodiment, however, is that capacitance at the bolometer 102 junction, which is due to the long connecting busses, yields a node with a time constant of:

τ=2/[R_{Bol}(C_{BUS}+C_{S/D})]≈0.5μ sec<<T_{INT}, where T_{INT}=26−52μ sec

### Where:

R_{Bol}=Bolometer 102 resistance

### C_{BUS}=Connecting Bus Capacitance

C_{S/D}=Capacitance of the MOSFET switch source/drain
T_{INT}=ROIC integrator integration time τ=Node electrical time constant

At the start of integration, charging of this node adds an offset to the signal integrator output. One way to resolve this issue would be to extend the signal integrator reset until the node is fully initialized (˜2 to 3μ sec).

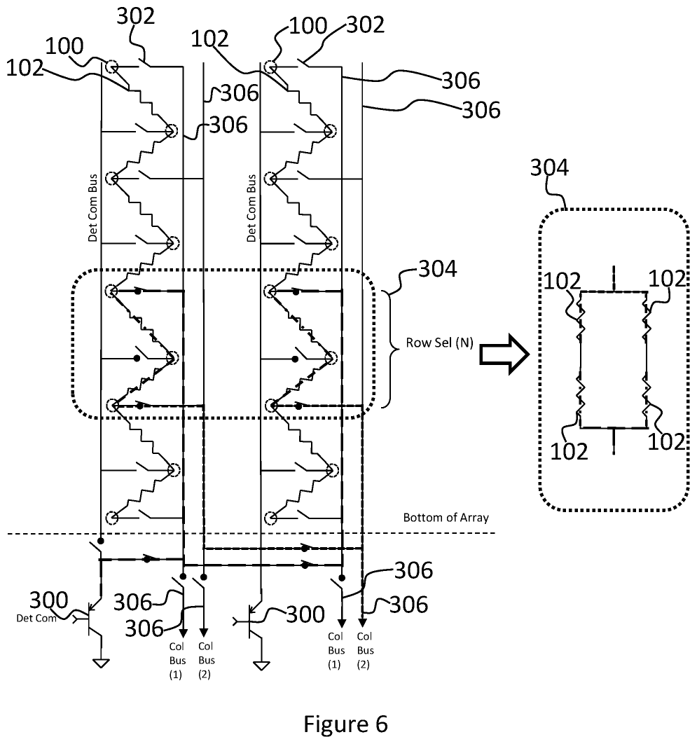

Now referring to FIG. 6, another option to allow switching between multiple resolutions is shown. In FIG. 6, the desired series-parallel combination of four adjacent bolometers 102 can be achieved by reconfiguring the DET_COM 300 and COL_BUS 306 lines of adjacent columns. Such embodiments require no changes or additions to the standard switch 302 configuration of the bolometer 102 array. Furthermore, in such embodiments, switches are added below the bottom of the array where ample space is available. In embodiments, a total of seven switches are required by such a configuration. This approach can easily be extended to 3×3, 4×4, N×N, etc., composite pixels. Such an approach also does not have the high resistance capacitive nodes present in embodiments in accordance with FIG. 5, as nodes tied to long metal busses 300/306 are the same, relatively low impedance nodes present in the baseline, full resolution mode.

To evaluate the true responsivity difference between the single and composite bolometer 102 configurations, we must understand the detailed behavior of the microbolometer 102, as the actual response performance is somewhat more complicated than the first order expression shown earlier:

$${Response}_{Simple} = \frac{{η}_{opt} {A}_{pix} I ( {T}_{scene} )}{4 {F}^{2}} \frac{α}{G} \frac{{V}_{bias}}{{R}_{bol}} \qquad Equation 22$$

### Where:

### G=Thermal Conductance of the Bolometer 102 Legs

F=F/# of the camera optics

### α=Bolometer 102 Temperature Coefficient of Resistance (TCR)

### R_{bol}=Bolometer 102 Resistance

nₒₚₜ=Camera Optics Transmission

### T_{scene}=Scene Temperature

### Aₚᵢₓ=Bolometer 102 Pixel Area

### V_{bias}=Voltage Bias

A more comprehensive analysis must account for the fact that the bolometer 102 temperature rises as a result of the applied pulse bias by an amount [symbol] T_{PB}. In typical applications, [symbol] T_{PB} can be as high as 25° C. As a result, the resistance drops and the response increases. A better approximation can be derived:

$${Response}_{Actual} ≅ {Response}_{Simple} ( \frac{1}{1 - \frac{1}{2} αΔ {T}_{PB}} ) \qquad Equation 23$$

### Where:

$$Δ {T}_{PB} ≅ \frac{{V}_{Bias}^{2}}{{R}_{Bol} G} \frac{{T}_{INT}}{τ} \qquad Equation 24$$

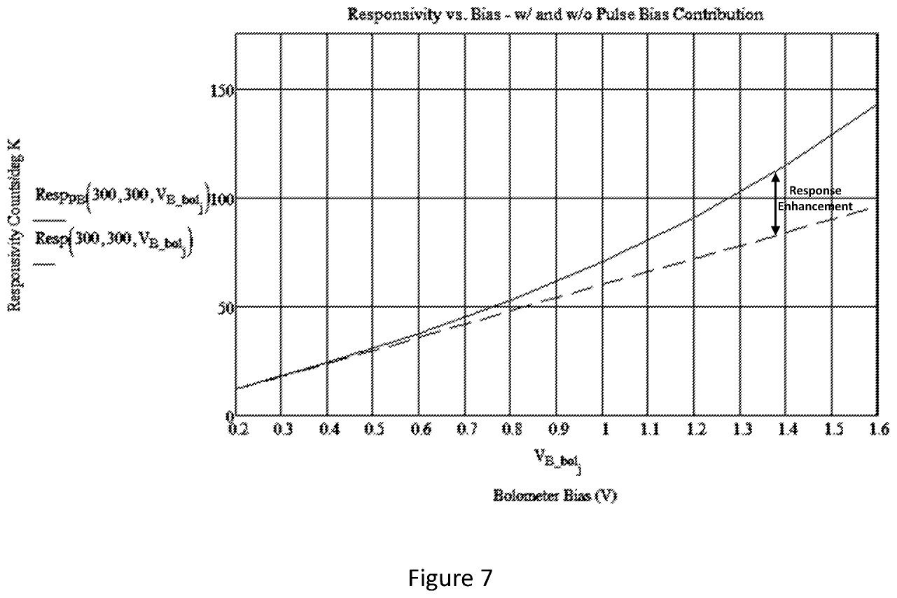

The plot shown in FIG. 7 is the result of a more accurate numerical solution. Since bolometer 102 heating increases with bias voltage, the divergence from the simple linear model, or response enhancement, increases with bias (Note that [symbol] _{PB} must be limited to ≤1/α ≈50° C. to prevent thermal runaway, in embodiments).

In practice, since each bolometer 102 in the composite (2×2 or four bolometer 102) case experiences half of the overall bias voltage, it experiences a lower [symbol] T_{PB} and therefore sees less response enhancement. Although the first order linear response is the same for both cases, the composite bolometer 102 must be provided with a higher bias voltage to achieve the same overall response (linear+enhanced). In embodiments, additional necessary bias voltage is only 100 to 300 mV for constant bias time.

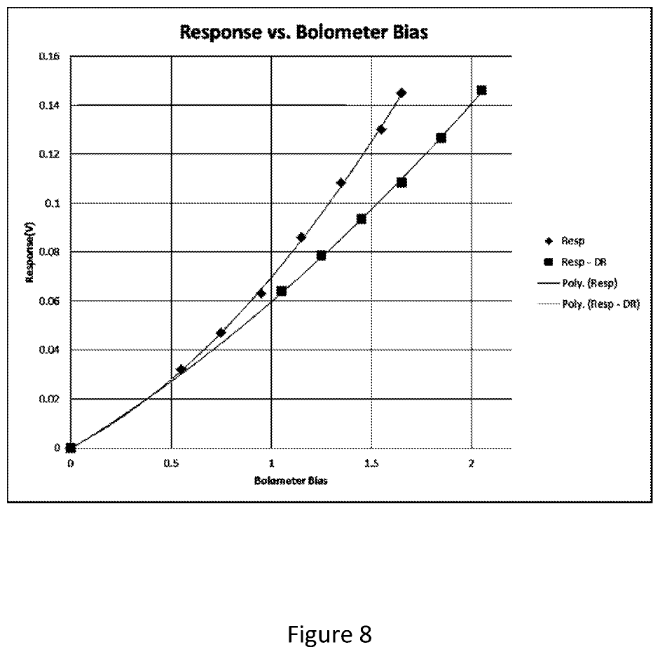

FIG. 8 is a plot showing a full front-end (Preamp/Coarse Digital-to-Analog converter (DAC)) SPICE (Simulation Program with Integrated Circuit Emphasis) circuit simulation including a Verilog-A bolometer 102 model, which accounts for bias heating, for the case of constant bias pulse and integration time. In this simulation heating compensation was optimized for each bias and an output delta for 50 mK temperature difference was used.

In embodiments, the composite array can be operated at higher bias, thereby achieving higher first order response and lower NETD.

In embodiments, operating in the composite mode allows the individual bolometers 102 to operate at a relatively lower bias, preventing them from heating as much as the native array case.

Now regarding power consumption, the following operational changes occur between modes:
Reduction in the number of active columns (2×)—Disabled by ROIC;
Reduction in the number of biased bolometers per line (2×);
Change in composite bolometer bias due to 2× increase in row pulse time;
Reduction in digital power due to reduction in readout rate; and
Bolometer 102 bias voltage is reduced due to an increase in pulse time, but must increase to maintain response.

Such operational changes result in total composite mode power, in the case of a 2×2 composite bolometer 102 circuit, being 71% of the native format. Although most power scales by 2×, bolometer 102 power is only reduced by 25%.

In conclusion, the multiple resolution FPA disclosed herein offers significant power and performance benefits over the current state of the art. Embodiments of the FPA disclosed herein can be operated in a high resolution, higher power mode and then switched to a ½× resolution, ¼× resolution, etc. lower power mode, while maintaining full fill factor and field of view. Processing ¼ of the pixels (in the case of a 2×2 composite bolometer 102 operating at ½× resolution) yields a comparable reduction in system power when full resolution is not needed. This is ideal for handheld, battery powered applications.

Resolution/Power reduction is accomplished by forming 2×2 composite pixels made up of series/parallel microbolometer 102 combinations. The approach can easily be extended to 3×3, 4×4, etc., composite pixels. The electrical behavior yields response and noise performance equivalent to a single bolometer 102.

The thermal properties of the composite pixel allow for increased biasing, yielding enhanced NETD performance relative to a single pixel.

Approaches disclosed herein only require the addition of switches outside of the input cell array with straightforward control circuitry and enable innovative imaging system implementations with lower SWAP-C.

The foregoing description of the embodiments of the disclosure has been presented for the purposes of illustration and description. It is not intended to be exhaustive or to limit the disclosure to the precise form disclosed. Many modifications and variations are possible in light of this disclosure. It is intended that the scope of the disclosure be limited not by this detailed description, but rather by the claims appended hereto.

What is claimed is:

1. A multiple resolution focal plane array, the multiple resolution focal plane array comprising:
a focal plan array comprising a plurality of bolometers arranged into a plurality of columns and rows and a readout integrated circuit connected to said plurality of bolometers,
wherein said readout integrated circuit is configured to accumulate signal-induced current collected from each bolometer during an integration interval and then transfer the resultant signal onto output taps for readout, and
wherein said readout integrated circuit is configured to allow a selection between at least two bolometer configurations, a first configuration where bolometers are combined into super pixels comprising N×N series/parallel groupings of bolometers and a second configuration where said bolometers are used individually, forming pixels comprising only a single bolometer.

2. The multiple resolution focal plane array of claim 1 wherein selection between the at least two bolometer configurations is accomplished using switches internal to the readout integrated circuit that are positioned between adjacent columns of pixels.

3. The multiple resolution focal plane array of claim 1 wherein selection between the at least two bolometer configurations is enabled by connecting detector common and column bus lines of adjacent columns of the readout integrated circuit with switches.

4. The multiple resolution focal plane array of claim 3 wherein said switches are added below a bottom portion of the focal plane array.

5. The multiple resolution focal plane array of claim 3 wherein a total of seven switches are used to connect detector common and column bus lines of adjacent columns of the readout integrated circuit.

6. The multiple resolution focal plane array of claim 1 wherein said readout integrated circuit is configured to use a dual row bias per line time to maximize pulse bias time.

7. The multiple resolution focal plane array of claim 1 wherein the selection between at least two bolometer configurations is accomplished electronically through the use of switches that, when used in combination with one another, re-configure row select signals and column interconnect signals between an input cell array and column signal processing circuitry.

8. The multiple resolution focal plane array of claim 1 wherein the selection between at least two bolometer configurations is performed on-FPA.

9. The multiple resolution focal plane array of claim 1 wherein each parallel/series grouping of bolometers uses at least two thermal-only contacts and at least 4 thermal/electrical contacts to connect adjacent bolometers when in said first configuration.

10. The multiple resolution focal plane array of claim 9 wherein said bolometers connected in series are connected to one another by thermal contacts only and said bolometers connected in parallel are connected to the readout integrated circuit and to adjacent series-connected bolometers by thermal/electrical contacts, when in said first configuration.

11. The multiple resolution focal plane array of claim 9 wherein said thermal/electrical contacts are tungsten posts.

12. The multiple resolution focal plane array of claim 9 wherein said tungsten posts connect the bolometers to the readout integrated circuit.

13. The multiple resolution focal plane array of claim 1 wherein bolometers in a column are connected in series.

14. The multiple resolution focal plane array of claim 1 wherein bolometers in each row of said focal plane array are selected simultaneously through a set of switches on the readout integrated circuit.

15. The multiple resolution focal plane array of claim 14 wherein said switches are controlled by hardware.

16. The multiple resolution focal plane array of claim 14 wherein said switches are controlled by software.

17. The multiple resolution focal plane array of claim 16 wherein said software enables said first or second configuration automatically, based on criteria selected from the group consisting of battery power, required image quality, and altitude.

18. The multiple resolution focal plane array of claim 1 wherein said focal plane array is configured to operate at a higher bias voltage when in said first configuration, as compared to said second configuration.

19. A multiple resolution focal plane array, the multiple resolution focal plane array comprising:
a focal plan array comprising a plurality of bolometers arranged into a plurality of columns and rows and a readout integrated circuit connected to said plurality of bolometers,
wherein said readout integrated circuit is configured to accumulate signal-induced current collected from each bolometer during an integration interval and then transfer the resultant signal onto output taps for readout, and
wherein said readout integrated circuit is configured to allow a selection between at least two bolometer configurations, a first configuration where bolometers are combined into super pixels comprising N×N series/parallel groupings of bolometers and a second configuration where said bolometers are used individually, forming pixels comprising only a single bolometer,
wherein selection between the at least two bolometer configurations is enabled by connecting detector common and column bus lines of adjacent columns of the readout integrated circuit with switches, and
wherein said switches are added below a bottom portion of the focal plane array.

20. A multiple resolution focal plane array, the multiple resolution focal plane array comprising:
a focal plan array comprising a plurality of bolometers arranged into a plurality of columns and rows and a readout integrated circuit connected to said plurality of bolometers,
wherein said readout integrated circuit is configured to accumulate signal-induced current collected from each bolometer during an integration interval and then transfer the resultant signal onto output taps for readout, and
wherein said readout integrated circuit is configured to allow a selection between at least two bolometer configurations, a first configuration where bolometers are combined into super pixels comprising N×N series/parallel groupings of bolometers and a second configuration where said bolometers are used individually, forming pixels comprising only a single bolometer,
wherein selection between the at least two bolometer configurations is enabled by connecting detector common and column bus lines of adjacent columns of the readout integrated circuit with switches,
wherein said switches are added below a bottom portion of the focal plane array, and
wherein said bolometers connected in series are connected to one another by thermal contacts only and bolometers connected in parallel are connected to the readout integrated circuit and to adjacent series-connected bolometers by thermal/electrical contacts, when in said first configuration.
